(19) United States
(12) Patent Application Publication
(10) Pub. No.: US 2020/0238632 A1
(43) Pub. Date: Jul. 30, 2020

(54) INSTALLATION OF COMPONENTS OF AN INTERNAL COMBUSTION ENGINE USING WIRELESS TAGS

(71) Applicant: GM GLOBAL TECHNOLOGY OPERATIONS LLC, Detroit, MI (US)

(72) Inventors: Fabio Numidi, Agliè (IT); Andrea Palma, Giaveno (TO) (IT)

(21) Appl. No.: 16/258,064

(22) Filed: Jan. 25, 2019

(51) Int. Cl. B29C 65/00; H04B 5/00; F02B 33/18; H04W 4/02

(52) U.S. Cl. CPC B29C 66/9672; H04W 4/02; F02B 33/18; H04B 5/0031

(57) ABSTRACT

A system for assembling components of an internal combustion engine assembly includes a wireless tag attached to each of a plurality of components of the engine assembly, each wireless tag attached to a respective component of the plurality of components and configured to be read to acquire guidance information related to manufacture of the engine assembly. The guidance information provides at least one of weight information and matching information, the matching information indicating a matching component that is configured to be connected to the respective component. The system also includes a processing device configured to perform: acquiring the guidance information for the respective component by reading the wireless tag, and tracking the respective component and the plurality of components during manufacturing of the engine assembly to guide installation of the respective component and the plurality of components based on the guidance information.

### INTRODUCTION

The subject disclosure relates to the art of motor vehicles and, more particularly, to a manufacturing system and method for assembling components of an internal combustion engine.

Internal combustion engines rely on pistons to drive a crankshaft coupled to a fly wheel. Currently, engine manufacturers machine, drill or otherwise modify engine components prior to assembly to limit weight variations and minimize weight imbalance. For example, crankshafts and pistons are typically machined to limit weight variations, and crank counterweights are physically drilled to correct and/or reduce weight imbalance.

### SUMMARY

In one exemplary embodiment, a system for assembling components of an internal combustion engine assembly includes a wireless tag attached to each of a plurality of components of the engine assembly, each wireless tag attached to a respective component of the plurality of components and configured to be read to acquire guidance information related to manufacture of the engine assembly. The guidance information provides at least one of weight information and matching information, the matching information indicating a matching component that is configured to be connected to the respective component. The system also includes a processing device configured to perform: acquiring the guidance information for the respective component by reading the wireless tag, and tracking the respective component and the plurality of components during manufacturing of the engine assembly to guide installation of the respective component and the plurality of components based on the guidance information.

In addition to one or more of the features described herein, the processing device is further configured to encode each wireless tag with an identifier and at least one of data indicating the guidance information and a memory location of the data indicating the guidance information.

In addition to one or more of the features described herein, the engine assembly includes a crankshaft, and the plurality of components are configured to be installed on the crankshaft.

In addition to one or more of the features described herein, the weight information includes a weight classification of the respective component.

In addition to one or more of the features described herein, the weight classification is based on an actual weight of the respective component when the engine assembly is manufactured.

In addition to one or more of the features described herein, the processing device is configured to determine a location on the engine assembly at which the respective component is to be installed based on the weight classification to facilitate weight balancing of the engine assembly.

In addition to one or more of the features described herein, the engine assembly includes a crankshaft, and the location is determined based on the weight classification and a weight balance properties of the crankshaft.

In addition to one or more of the features described herein, the matching information includes an identification of an other component that is configured to be connected to the respective component in the engine assembly.

In addition to one or more of the features described herein, the processing device is configured to track the respective component and the other component during the manufacturing to ensure that the respective component is connected to the other component.

In addition to one or more of the features described herein, the engine assembly includes a crankshaft, the respective component is one of a connecting rod and a lower bearing cap, and the other component is another of the connecting rod and the lower bearing cap.

In another exemplary embodiment, a method of assembling components of an internal combustion engine assembly includes encoding a wireless tag attached to each of a plurality of components of the engine assembly with guidance information related to manufacture of the engine assembly, each wireless tag attached to a respective component of the plurality of components and configured to be read to acquire the guidance information. The guidance information provides at least one of weight information and matching information, the matching information indicating a matching component that is configured to be connected to the respective component. The method also includes acquiring, by a processing device, the guidance information for the respective component by reading the wireless tag, and tracking the respective component and the plurality of components during manufacturing of the engine assembly to guide installation of the respective component and the plurality of components based on the guidance information.

In addition to one or more of the features described herein, the processing device is configured to encode each wireless tag with an identifier and at least one of data indicating the guidance information and a memory location of the data indicating the guidance information.

In addition to one or more of the features described herein, the engine assembly includes a crankshaft, and the plurality of components are configured to be installed on the crankshaft.

In addition to one or more of the features described herein, the weight information includes a weight classification of the respective component.

In addition to one or more of the features described herein, the weight classification is based on an actual weight of the respective component when the engine assembly is manufactured.

In addition to one or more of the features described herein, the method further includes determine a location on the engine assembly at which the respective component is to be installed based on the weight classification to facilitate weight balancing of the engine assembly.

In addition to one or more of the features described herein, the engine assembly includes a crankshaft, and the location is determined based on the weight classification and a weight balance properties of the crankshaft.

In addition to one or more of the features described herein, the matching information includes an identification of an other component that is configured to be connected to the respective component in the engine assembly.

In addition to one or more of the features described herein, the method further includes tracking the respective component and the other component during the manufacturing to ensure that the respective component is connected to the other component.

In addition to one or more of the features described herein, the engine assembly includes a crankshaft, the respective component is one of a connecting rod and a lower bearing cap, and the other component is another of the connecting rod and the lower bearing cap.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including an internal combustion engine having a crankshaft, in accordance with an exemplary embodiment;

FIG. 2 is a perspective view of a crankshaft, in accordance with an aspect of an exemplary embodiment;

FIG. 3 is a perspective view of a connecting rod and a piston configured to be installed on a crankshaft,

FIG. 4 is a perspective view of an assembly station, in accordance with an aspect of an exemplary embodiment;

FIG. 5 is a top view of a piston having a wireless tag, in accordance with an aspect of an exemplary embodiment;

FIG. 6 is a top perspective view of a connecting rod lower bearing cap having a wireless tag, in accordance with an aspect of an exemplary embodiment;

FIG. 7 is a top perspective view of a connecting rod lower bearing cap having a wireless tag, in accordance with an aspect of an exemplary embodiment;

FIG. 8 depicts examples of engine components having wireless tags that provide component weight information, in accordance with an aspect of an exemplary embodiment;

FIG. 9 depicts a computer system for performing aspects of tracking components during manufacture of an engine assembly and/or performing aspects of manufacturing an engine assembly, in accordance with an aspect of an exemplary embodiment;

FIG. 10 is a flow chart depicting aspects of a method of manufacturing an engine assembly, in accordance with an aspect of an exemplary embodiment;

FIG. 11 depicts aspects of estimating weight properties of a crankshaft, in accordance with an aspect of an exemplary embodiment;

FIG. 12 depicts the assignment of position and weight classification information to components of an engine assembly, in accordance with an aspect of an exemplary embodiment;

FIG. 13 depicts aspects of reading wireless tags and tracking engine assembly components, in accordance with an aspect of an exemplary embodiment; and

FIG. 14 depicts aspects of reading wireless tags and tracking engine assembly components, in accordance with an aspect of an exemplary embodiment.

### DETAILED DESCRIPTION

The following description is merely exemplary in nature and is not intended to limit the present disclosure, its application or uses.

In accordance with one or more exemplary embodiments, methods and systems for manufacturing an engine assembly or portions thereof are described herein. An embodiment of a method of manufacturing an engine assembly includes assigning guidance information to each of a plurality of components of the engine assembly. The guidance information is assigned by encoding information on a wireless tag adhered to or otherwise fixedly disposed on each component. For example, a wireless tag can be affixed to each piston and connecting rod to be installed on a crankshaft during manufacture or assembly of a crankshaft assembly. An example of a wireless tag is a data matrix code (DMC) or barcode tag that can be read by a laser or camera.

In one embodiment, the guidance information includes matching information that identifies components (matching components) that are to be connected together or otherwise installed at the same or at a similar location. The wireless tags can be periodically read or scanned during manufacturing to ensure that matching components are properly installed together.

In one embodiment, the guidance information includes weight information associated with each component. For example, weight information is encoded on each wireless tag, which may be a weight value or weight classification based on the actual weight of a respective component at the time of manufacture. The weight information can be accessed by a processing device by reading weight information data directly from the tag or by reading weight information stored in a memory location (e.g., a server or computer memory) indicated by data encoded on the tag.

Prior to or during manufacture of an engine assembly and/or crankshaft assembly, the weight information can be used to determine a desired location of each component. For example, a crankshaft is weighed to estimate weight balance properties of the crankshaft, and the weight classification of each connecting rod and piston is used to determine a location where each connecting rod and piston is to be placed to balance the weight of the entire crankshaft assembly. Each piston and connecting rod is read or scanned during manufacture to facilitate placement and installation at desired locations.

Embodiments described herein have numerous advantages. For example, the embodiments can be used to locate and match components based on weight variations in components, which can reduce the time and cost by avoiding the need to machine, drill or otherwise modify components during manufacture. In addition, the system provides error proofing capability by allowing for the tracking of each component and its assigned location to ensure that each component is properly matched with a matching component (where necessary) and properly located in the crankshaft assembly and/or engine assembly.

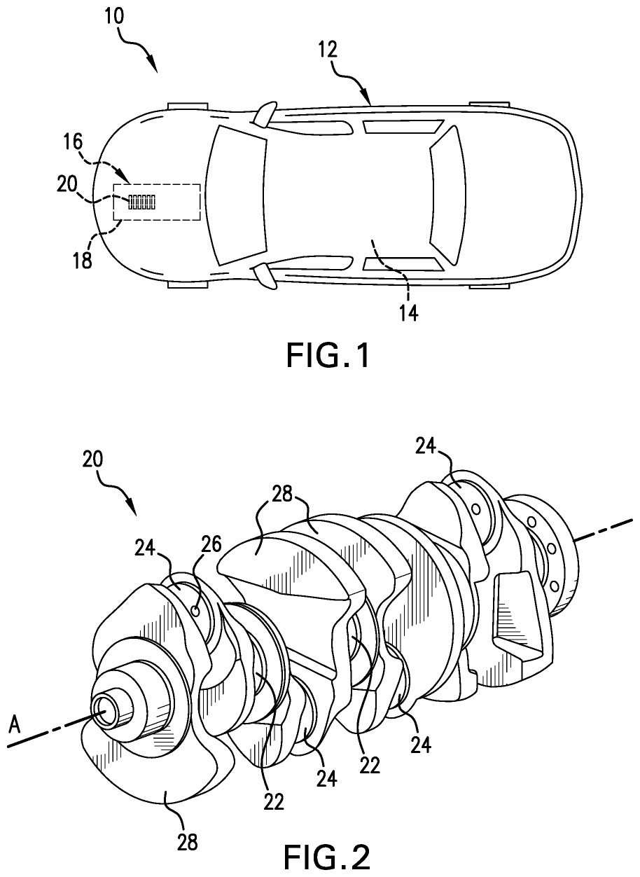

FIG. 1 shows an example of a motor vehicle 10, which includes a vehicle body 12 defining, at least in part, an occupant compartment 14. Vehicle body 12 also supports an engine assembly 16 including an internal combustion engine. The engine assembly 16 includes a crankshaft assembly 18 having a number of pistons (not shown) and a crankshaft 20 that are formed from steel or other suitable materials.

FIG. 2 illustrates an example of a crankshaft 20 that includes a plurality of main journals 22, which are coupled to an engine block (not shown) of the engine assembly 16 through main bearings caps (also not shown). The main journals 22 define an axis of rotation “A” of the crankshaft 20. The crankshaft 20 also includes a plurality of crank pins 24 (bearing journals) that are connected to pistons (not shown) through connecting rods (not shown). Each crank pin 24 includes a crank pin oil hole 26. The crankshaft 20 further includes a plurality of counterweights 28.

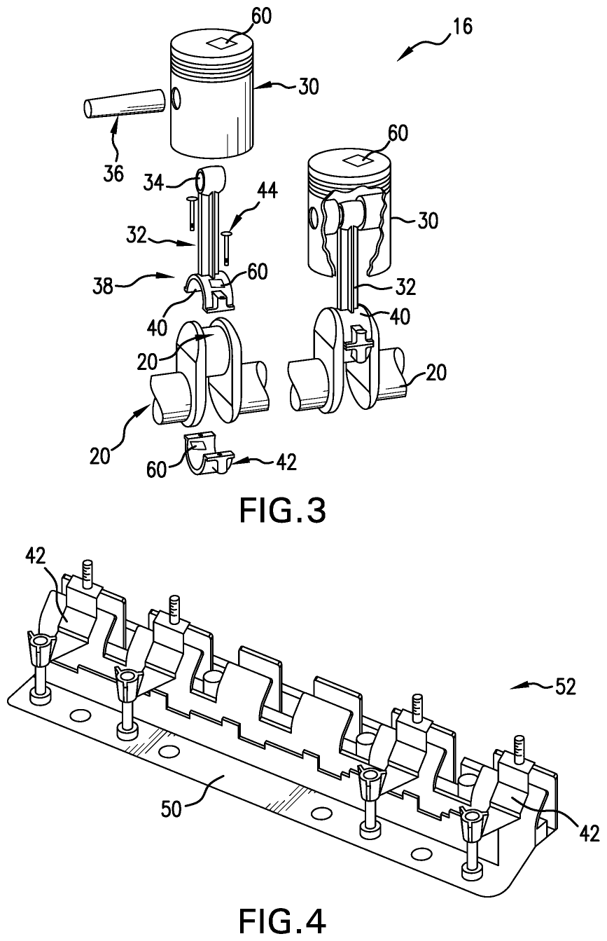

Referring to FIG. 3, the engine assembly 16 includes a variety of components, such as a plurality of pistons 30 that reciprocate in respective cylinders (not shown). Each piston 30 is connected to a connecting rod 32 that is installed on one of the crank pins 24. Each connecting rod 32 has a first end 34 that connects to a piston 30 via a piston pin 36. A second end 38 includes a rod bearing having an upper bearing cap 40 and a lower bearing cap 42. The upper bearing cap 40 and the lower bearing cap 42 are installed on a crank pin 24 and connected via bolts 44, or other suitable connection mechanism.

When the engine assembly 16 is assembled, components should be properly matched and positioned to properly balance the weight of the assembly. For example, each connecting rod 32 is provided with a matching lower bearing cap 42. The lower bearing caps 42 are typically manually arranged in selected positions on an assembly rack 50 at an assembly station 52, as shown in FIG. 4. Matching connecting rods 32 are later installed on the crankshaft 20 at the prescribed positions. In such cases, there is a risk of mixing, i.e., the wrong connecting rod 32 is installed at an incorrect position and thus is connected to a non-matching lower bearing cap 42. This can result in imbalancing and/or bearing seizure.

Embodiments of a manufacturing and/or assembly system and method are provided that address the above challenges in assembly and weight balancing during manufacture of an engine assembly. The system includes a wireless tag 60 attached to each of a plurality of engine assembly components or parts. For example, as shown in FIG. 3, one or more of the piston 30, the connecting rod 32 and the connecting rod lower bearing cap 42 has a wireless tag 60 attached thereto. The system also includes a processing device to perform functions such as encoding the wireless tags 60, reading information from the wireless tags 60 and tracking components during manufacturing of an engine assembly and/or a crankshaft assembly.

Each tag 60 provides information regarding the component or part to which the tag 60 is fixed. The information may include a component identifier, such as a model number, part number or other identifier. The information may utilize existing codes or identifiers, such as part information encoded by a component manufacturer (e.g., part number and/or serial number). For example, the wireless tag 60 includes a RPO code or product code.

Each tag 60 may provide information (“guidance information”), in addition to an identifier, which can be used to guide manufacturing and/or installation of components. The guidance information can be used during manufacturing and/or installation to eliminate potential error sources due to mixing components or installing components at incorrect positions. The guidance information can also be used to reduce or minimize imbalances.

The guidance information can include location information that indicates a location or position at which a component is to be installed. For example, location information encoded on a tag 60 affixed to a connecting rod 32 can indicate which crank pin of a crankshaft on which the connecting rod 32 is to be installed.

In one embodiment, the classification information includes information that identifies parts or components that are to be paired during assembly, referred to herein as “matching parts” or “matching components.” Matching parts include components that are meant to be attached to one another and/or positioned at the same or similar location. For example, each connecting rod 32 has a corresponding lower bearing cap 42. Thus, for a given connecting rod 32, the wireless tag 60 on the given connecting rod 32 includes information that allows a corresponding lower bearing cap 42 to be matched.

In another example, if a given piston 30 is to be paired with (connected to) a given connecting rod 32, the respective tags 60 are encoded with matching information such as a common indicator (e.g., a number). During installation, a camera check can be used to check whether the piston 30 and the connecting rod 32 have been put in the correct position, e.g., that they are in the same position or in the same cylinder. Such a check allows for detection of any possible mixing error before manufacturing is complete and before any damage occurs due to a wrong match.

In one embodiment, the information encoded on a tag 60 for a respective component includes weight information associated with the respective component. The weight information may include a value representing the actual weight of the respective component when manufacturing and/or installation is performed. In one embodiment, the weight information includes a weight classification that represents a range of weight values. Multiple weight classifications may be provided. A component having a weight within a specific weight range is assigned the weight classification associated with the specific weight range.

It is noted that each tag 60 may be encoded to provide the identifier and guidance information in a variety of manners. For example, the tag 60 may be encoded directly with data that can be read to acquire the guidance information (e.g., a weight classification or matching indicator), or data encoded on the tag 60 can be an indicator that directs a processing device to acquire the guidance information from a storage location (e.g., on a server, a computer and/or a mobile device).

The wireless tag 60 may be of any suitable type that allows for wireless reading or scanning. Examples of wireless tags 60 include tags configured to communicate via wireless local area networking (wi-fi), radio frequency identification (RFID) tags, one or two-dimensional bar codes and others. The tags 60 may be read by, for example, radio signals, optical scanning and/or any other mechanism for reading data.

In one embodiment, the wireless tags 60 are configured as Data Matrix Code (DMC) tags. DMC is a two-dimensional bar code that forms cells in a square or rectangular pattern. DMC tags are readable by an optical camera or other optical scanner. The wireless tags 60 may be configured as other types of two-dimensional bar codes, such as dot codes and Quick Response (QR) codes.

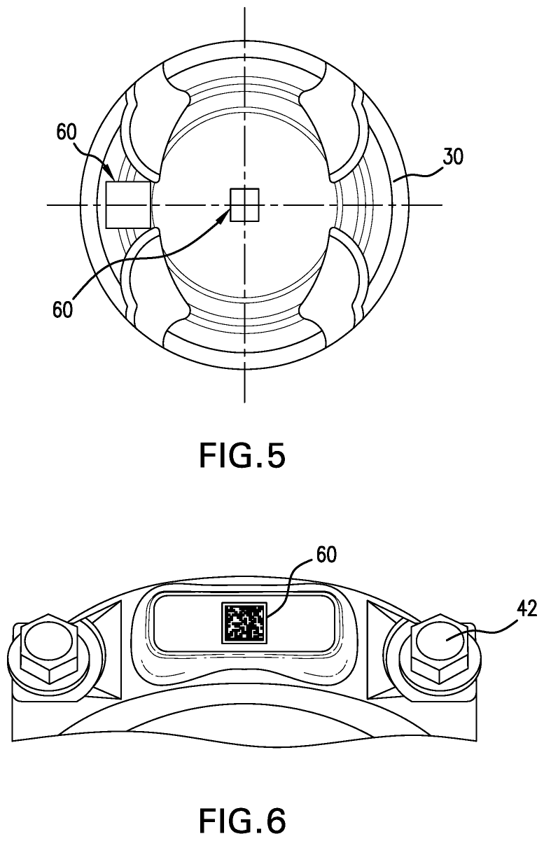

FIGS. 5-7 show examples of wireless tags 60 and their placement on various engine assembly components. The tags 60 may be affixed to the components in any suitable manner. For example, the tags can be adhered to a surface or printed directly onto the surface of a component.

In some embodiments, one or more tags 60 can be applied during manufacture of the component, e.g., by adhering the tag after inspection. Such pre-applied tags can then be used as discussed herein to program additional guidance information.

FIG. 5 shows an exemplary placement of a wireless tag 60 on a piston 30. In this example, the wireless tag 60 is a rectangular or square DMC tag affixed to a top surface of the piston 30. For example, the DMC tag is a square tag having 10.8 mm sides located offset from the center of the top surface, or a 3.5 mm by 3.5 mm tag in the center of the top surface.

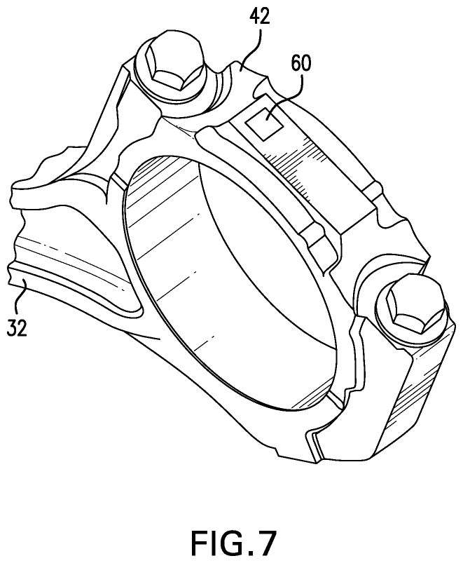

FIGS. 6 and 7 show examples of placement of a wireless tag 60 on a lower bearing cap 42. In FIG. 6, the wireless tag is adhered onto a surface of the lower bearing cap 42. In FIG. 7, the wireless tag 60 is deposited or printed on the surface of the lower bearing cap 42.

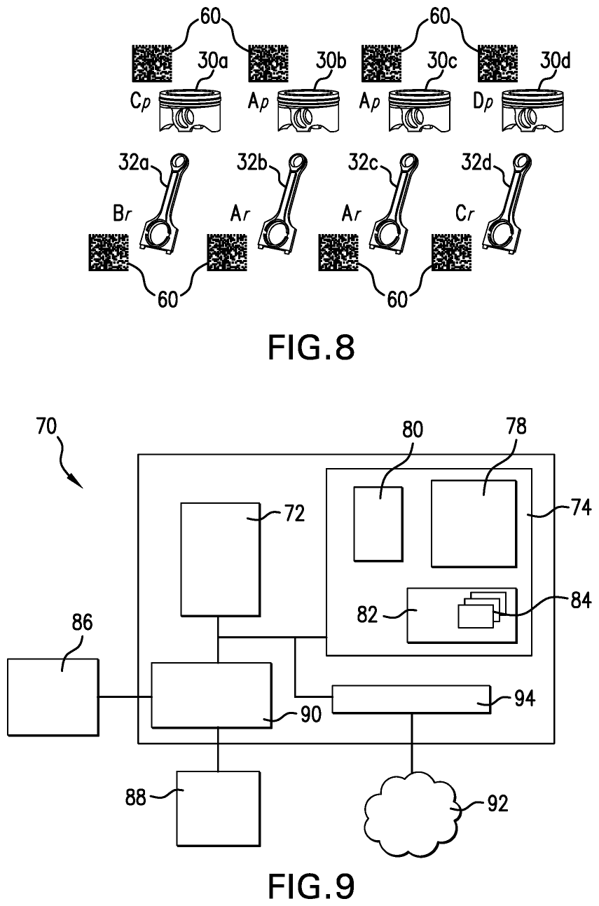

FIG. 8 shows an example of weight classification information related to component weights, which can be used to ensure proper balancing. A plurality of pistons 30a, 30b, 30c and 30d are acquired for use in manufacturing a crankshaft assembly. Each piston 30a-30d is weighed and assigned a weight classification. In this example, the weight classifications are denoted as Class Ap, Class Bp, Class Cp and Class Dp, each of which represents a selected range of weight values. The classes may be assigned in order of increasing weight ranges (i.e., class Ap represents a lowest weight range and class Dp represents a highest weight range).

In addition, in this example, a plurality of connecting rods 32a, 32b, 32c and 32d are acquired and weighed, and assigned a weight classification based thereon. For example, the connecting rods 32a-32d are each assigned a weight class Ar, Br, Cr or Dr. The classes may be assigned in order of increasing weight ranges, i.e., Class Ar represents a lowest weight range and Class Dr represents a highest weight range.

The weight classification information can then be used to select locations on a crankshaft to achieve weight balance. For example, the crankshaft 20 of FIG. 3 and components thereof are weighed to determine the weight balance or imbalance of the crankshaft 20 itself (prior to installation of connecting rods or pistons). Locations or positions along the crankshaft 20 at which each piston and connecting rod are to be installed are selected based on the weight classification and weight balance properties of the crankshaft 20.

Each wireless tag 60 can be scanned or otherwise read to determine the associated weight class of a respective piston 30 or connecting rod 32 at various stages during manufacture, and ensure that the respective piston 30 or connecting rod 32 is properly located. For example, each connecting rod 32a-32d is scanned when the connecting rods 32a-32d are arranged on an assembly rack and/or when the connecting rods 32a-32d are installed on the crank pins 24 of the crankshaft 20.

FIG. 9 shows an embodiment of a computer system 70 configured to perform various functions related to reading wireless tags, tracking components, matching components, and guiding aspects of assembling components during manufacture of an engine assembly. The computer system 70 may be used in conjunction with one or more assembly stations or systems, such as the assembly station 52 of FIG. 4.

Components of the computer system 70 include one or more processors or processing units 72, a system memory 74, and a bus 76 that couples various system components including the system memory 74 to the one or more processing units 72. The system memory 74 may include a variety of computer system readable media. Such media can be any available media that is accessible by the processing unit(s) 72, and includes both volatile and non-volatile media, removable and non-removable media.

For example, the system memory 74 includes a storage system 78 for reading from and writing to a non-removable, non-volatile memory (e.g., a hard drive). The system memory 74 may also include volatile memory 80, such as random access memory (RAM) and/or cache memory. The computer system 70 can further include other removable/non-removable, volatile/non-volatile computer system storage media.

As will be further depicted and described below, system memory 74 can include at least one program product having a set (e.g., at least one) of program modules that are configured to carry out functions of the embodiments described herein.

For example, the system memory 74 stores a program/utility 82, having a set (at least one) of program modules 84. The program/utility 82 may be an operating system, one or more application programs, other program modules, and program data. The program modules 84 generally carry out the functions and/or methodologies of embodiments described herein. For example, the program modules 84 can include modules for acquiring input data from, e.g., a tag reader, identifying and assigning components, guiding the installation of components and/or performing stages of manufacturing a crankshaft assembly and/or engine assembly.

The one or more processing units 72 can also communicate with one or more external devices 86 such as a keyboard, a pointing device, a display, and/or any devices (e.g., network card, modem, etc.) that enable the one or more processing units 72 to communicate with one or more other computing devices. In addition, the one or more processing units 72 can communicate with a wireless tag reader 88, such as a camera or laser scanner. Such communication can occur via Input/Output (I/O) interfaces 90.

The one or more processing units 72 can also communicate with one or more networks 92 such as a local area network (LAN), a general wide area network (WAN), and/or a public network (e.g., the Internet) via a network adapter 94. It should be understood that although not shown, other hardware and/or software components could be used in conjunction with the computing system 10. Examples include, but are not limited to: microcode, device drivers, redundant processing units, external disk drive arrays, RAID systems, tape drives, and data archival storage systems, etc.

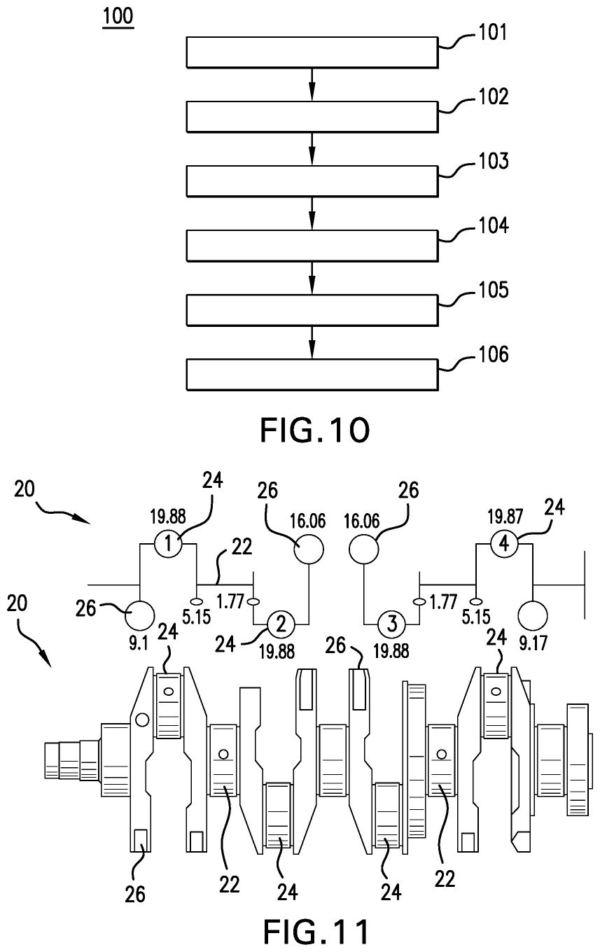

FIGS. 10-14 illustrate aspects of a method 100 of manufacturing an engine assembly or portions thereof. The computer system 70 or other processing device or system may be utilized for performing aspects of the method 100.

The method 100 is described as being performed to manufacture a crankshaft assembly, which includes installing various components on a crankshaft, such as the crankshaft 20 of FIG. 2.

In this embodiment, the crankshaft 20 has not been machined or drilled to compensate for weight imbalance, as the method 100 allows for balancing the crankshaft assembly by locating individual connecting rods and pistons according to their actual weight at the time of installation of the connecting rods and pistons. Thus, machining and/or drilling parts of the crankshaft 20 can be avoided. It is noted that the method 100 is also applicable to crankshafts that are or have been machined or drilled to compensate for weight imbalance.

Although the method 100 is discussed in conjunction with installing components on a crankshaft and manufacturing a crankshaft assembly, the method 100 is not so limited and can be applied to other assemblies and/or engine systems. For example, the method 100 can be used in manufacturing or assembling front engine assemblies (including pulleys) and rear transmission assemblies (including flexplates).

Referring again to FIG. 10, aspects of the method 100 may be performed manually and/or performed by a computer or processor such as the computer system 70. The method 100 is discussed in conjunction with blocks 101-106. The method 100 is not limited to the number or order of steps therein, as some steps represented by blocks 101-106 may be performed in a different order than that described below, or fewer than all of the steps may be performed.

At block 101, prior to manufacturing a crankshaft assembly, a plurality of components are provided with wireless tags. For example, each piston 30 is given a wireless tag 60 and each connecting rod 32 is given a wireless tag 60. The connecting rod 32 may have a single wireless tag, or have a wireless tag on an upper portion of the connecting rod 32 and on a lower bearing cap 42.

For example, four pistons 30a, 30b, 30c and 30d (as shown in FIG. 8) are provided for installation on the crankshaft 20, and each piston's tag is encoded with an identifier (e.g., a part number). In addition, four connecting rod assemblies are each provided with a wireless tag 60. A first connecting rod assembly includes a first connecting rod 32a and a first lower bearing cap 42a that are intended to be connected together on a crankshaft pin. Likewise, three additional connecting rod assemblies are provided, including a second connecting rod 32b and accompanying lower bearing cap 42b, a third connecting rod 32c and accompanying lower bearing cap 42c, and a fourth connecting rod 32d and accompanying lower bearing cap 42d. The tags 60 on each of the connecting rods 32a-32d and on each of the lower bearing caps 42a-42d are each encoded with an identifier. The identifier may be encoded during the method 100, or may be encoded prior to acquiring a component (e.g., encoded by the component manufacturer).

At block 102, in one embodiment, one or more of the wireless tags 60 are encoded to provide location information and/or matching information for a respective component. For example, the tags 60 on the first connecting rod 32a and the first lower bearing cap 42a are each provided with matching information (such as a matching indicator, e.g., a common numeric value or alphanumeric indicator). Likewise, the second connecting rod 32b and the second lower bearing cap 42b are provided with a matching indicator, the third connecting rod 32c and the third lower bearing cap 42c are provided with a matching indicator, and the fourth connecting rod 32d and the fourth lower bearing cap 42d are provided with a matching indicator.

In another example, if a specific connecting rod 32 and a specific piston 30 are to be installed together or paired together during assembling of the crankshaft assembly, matching information can be encoded thereon. For example, the first piston 30a and the first connecting rod 32a are both provided with a matching indicator. The encoding may have matching data directly thereon, such as a numerical identifier that matches the parts, or may encode a memory location in which the matching information is stored.

At block 103, the crankshaft 20 may be measured to estimate weight balance properties, e.g., to determine any weight imbalance. As discussed further below, information encoded in respective wireless tags 60 can be used to determine the weight of each connecting rod and piston. Based on the weight information, the location on the crankshaft 20 of the pistons 30a-30d and the connecting rods 32a-32d can be selected so that weight imbalance is reduced or minimized.

For example, as shown in FIG. 11, the weight of various components of the crankshaft 20 is measured. The measured weights are used to determine balance properties of the crankshaft (i.e., whether there is an imbalance in the crankshaft 20 and the extent of such imbalance). Based on the balance properties, it can be determined at which position on the crankshaft (Position 1, 2 3 or 4 as shown in FIG. 11) each component should be installed.

At block 104, in one embodiment, one or more components are given a weight classification, which is encoded on each respective tag 60 and/or stored in a memory location. For example, each piston 30a-30d is weighed and assigned to a weight classification. Exemplary weight classifications are denoted as Class Ap, Class Bp, Class Cp, and Class Dp, which represent increasing weight ranges. Likewise, each connecting rod 32a-32d is weighed and assigned to a weight classification, such as one of Class Ar, Class Br, Class Cr, and Class Dr, which represent increasing weight ranges.

At block 105, based on the measurement of crank imbalance and the weight classifications of various components, a location on the crankshaft 20 on which each component is to be installed is determined. For example, the crankshaft 20 of FIG. 11 does not show significant weight imbalance, potentially requiring only minor angular corrections. As discussed above, no extensive machining or drilling is required. The computer system 70 can determine which piston and connecting rod weight class combination is needed to compensate for any crankshaft imbalance and to minimize imbalance of the crankshaft assembly.

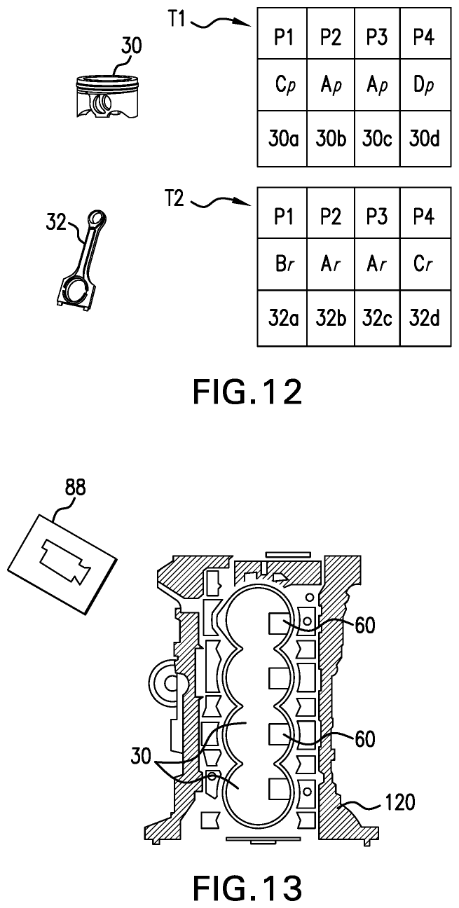

FIG. 12 shows an example of assignments of components based on their weight classification. In this example, pistons 30b and 30c are assigned the weight classification Ap (the lowest weight classification), piston 30a is assigned weight classification Cp, and piston 30d is assigned weight classification Dp. Connecting rods 32b and 32c are assigned the weight classification Ar (the lowest weight classification), connecting rod 32a is assigned weight classification Br, and connecting rod 32d is assigned weight classification Cr.

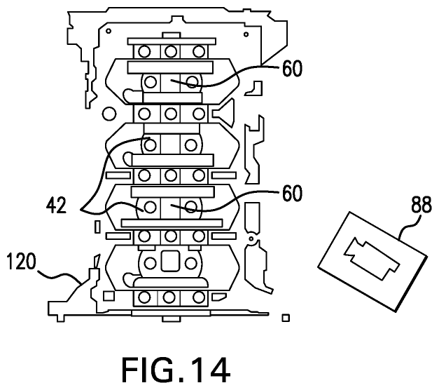

The computer system 70 calculates the most suitable location for each piston and connecting rod. The location, identification and/or weight information may be stored in a table or other suitable data structure. An example of such tables are shown in FIG. 14, which shows the result of location calculations performed to achieve maximum weight balancing. In this example, lower weight classes are assigned to Position 2 and Position 3, and higher weight classes are assigned to Position 1 and Position 4. Table T1 provides information relating to an assigned position for each weight class, and may also provide information relating to which piston 30 (for example, piston 30a, 30b, 30c or 30d) is assigned to each weight class and/or position. Likewise, table T2 provides information relating to an assigned position for each weight class, and may also provide information relating to which connecting rod 32 (for example, connecting rod 32a, 32b, 32c or 32d) is assigned to each weight class and/or position. This information is subsequently utilized during installation to ensure that the correct pistons and connecting rods are installed.

At block 106, installation of various components on the crankshaft 20 is commenced and components are tracked to ensure proper placement and matching. During installation, wireless tags 60 are scanned or read at various stages of the manufacturing process to ensure that matching components are properly connected together and/or installed at the same location.

For example, as shown in FIG. 4, connecting rod bearing caps 42 are arranged on an assembly rack that corresponds to positions on the crankshaft 20 (i.e., Positions 1-4). Each lower bearing cap 42 is positioned at the position prescribed by the weight and position information (e.g., the table at FIG. 14). As each lower bearing cap 42 is positioned, the corresponding wireless tag 60 is scanned to indicate to a user or processing device the proper location. Subsequently, as the lower bearing caps 42 are installed and connected to matching connecting rods 32, each component is again scanned to ensure that matching components are connected together at prescribed locations. This is performed prior to the rod bolt tightening so that errors can be avoided before any damage can occur.

Scanning and error proofing can be performed at various stages. For example, in addition to scanning the pistons and connecting rods as they are installed, the proper position of the pistons and connecting rods can be scanned during or after the crankshaft assembly is installed on an engine deck. As shown in FIG. 13, after the crankshaft assembly is installed in an engine block 120, a scanning device such as a camera or tag reader 88 is used to read tags 60 on the pistons 30 to ensure that they are properly positioned. In addition, as shown in FIG. 14, the tags 60 on lower bearing caps 42a re read to ensure that they are properly positioned.

The method 100 thus presents numerous advantages, such as the ability to reduce or neutralize any unbalancing in the crankshaft assembly, and to track and verify the crankshaft assembly's conformity to desired installation parameters. In addition, the method 100 can be used to eliminate the cost and time associated with machining operations that are usually performed to control and limit part weight variation in conventional manufacturing processes.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for assembling components of an internal combustion engine assembly, comprising:
a wireless tag attached to each of a plurality of components of the engine assembly, each wireless tag attached to a respective component of the plurality of components and configured to be read to acquire guidance information related to manufacture of the engine assembly, the guidance information providing at least one of weight information and matching information, the matching information indicating a matching component that is configured to be connected to the respective component; and
a processing device configured to perform:
acquiring the guidance information for the respective component by reading the wireless tag; and
tracking the respective component and the plurality of components during manufacturing of the engine assembly to guide installation of the respective component and the plurality of components based on the guidance information.

2. The system of claim 1, wherein the processing device is further configured to encode each wireless tag with an identifier and at least one of:
data indicating the guidance information; and
a memory location of the data indicating the guidance information.

3. The system of claim 1, wherein the engine assembly includes a crankshaft, and the plurality of components are configured to be installed on the crankshaft.

4. The system of claim 1, wherein the weight information includes a weight classification of the respective component.

5. The system of claim 4, wherein the weight classification is based on an actual weight of the respective component when the engine assembly is manufactured.

6. The system of claim 1, wherein the processing device is configured to determine a location on the engine assembly at which the respective component is to be installed based on the weight classification to facilitate weight balancing of the engine assembly.

7. The system of claim 6, wherein the engine assembly includes a crankshaft, and the location is determined based on the weight classification and a weight balance properties of the crankshaft.

8. The system of claim 1, wherein the matching information includes an identification of an other component that is configured to be connected to the respective component in the engine assembly.

9. The system of claim 8, wherein the processing device is configured to track the respective component and the other component during the manufacturing to ensure that the respective component is connected to the other component.

10. The system of claim 9, wherein the engine assembly includes a crankshaft, the respective component is one of a connecting rod and a lower bearing cap, and the other component is another of the connecting rod and the lower bearing cap.

11. A method of assembling components of an internal combustion engine assembly, comprising:
encoding a wireless tag attached to each of a plurality of components of the engine assembly with guidance information related to manufacture of the engine assembly, each wireless tag attached to a respective component of the plurality of components and configured to be read to acquire the guidance information, the guidance information providing at least one of weight information and matching information, the matching information indicating a matching component that is configured to be connected to the respective component;
acquiring, by a processing device, the guidance information for the respective component by reading the wireless tag; and
tracking the respective component and the plurality of components during manufacturing of the engine assembly to guide installation of the respective component and the plurality of components based on the guidance information.

12. The method of claim 11, wherein the processing device is configured to encode each wireless tag with an identifier and at least one of:
data indicating the guidance information; and
a memory location of the data indicating the guidance information.

13. The method of claim 11, wherein the engine assembly includes a crankshaft, and the plurality of components are configured to be installed on the crankshaft.

14. The method of claim 11, wherein the weight information includes a weight classification of the respective component.

15. The method of claim 14, wherein the weight classification is based on an actual weight of the respective component when the engine assembly is manufactured.

16. The method of claim 11, further comprising determining a location on the engine assembly at which the respective component is to be installed based on the weight classification to facilitate weight balancing of the engine assembly.

17. The method of claim 16, wherein the engine assembly includes a crankshaft, and the location is determined based on the weight classification and a weight balance properties of the crankshaft.

18. The method of claim 11, wherein the matching information includes an identification of an other component that is configured to be connected to the respective component in the engine assembly.

19. The method of claim 18, further comprising tracking the respective component and the other component during the manufacturing to ensure that the respective component is connected to the other component.

20. The method of claim 19, wherein the engine assembly includes a crankshaft, the respective component is one of a connecting rod and a lower bearing cap, and the other component is another of the connecting rod and the lower bearing cap.
